(19) United States
(12) Patent Application Publication
(10) Pub. No.: US 2004/0160521 A1
(43) Pub. Date: Aug. 19, 2004

(54) Image processing device

(75) Inventor: Yasuhiro Yamamoto, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/762,360

(22) Filed: Jan. 23, 2004

(30) Foreign Application Priority Data
Jan. 24, 2003 (JP) P2003-015804

(51) Int. Cl. H04N 5/335

(52) U.S. Cl. 348/272; 348/222.1

(57) ABSTRACT

An image processing device comprises first and second correlation value calculating processors, and a pixel data calculating processor. The first correlation value calculating processor obtains a first correlation value, relating to related pixels which are positioned in vertical and horizontal directions relative to an objective pixel. The second correlation value calculating processor obtains a second correlation value relating to four peripheral pixels which are positioned adjacent to the upper left, upper right, lower left, and lower right of the objective pixel. The pixel data calculating processor obtains the G-pixel data of the objective pixel, depending upon the first correlation value and the second correlation value.

### BACKGROUND OF THE INVENTION

1. Field of the Invention

The present invention relates to an image processing device which is mounted in a digital camera, for example, to perform an interpolation of red (R), green (G), and blue (B) pixel data obtained through an imaging device, so that G plane data is obtained.

2. Description of the Related Art

Conventionally, there is known a digital camera, in which R, G, and B color filters are arranged on a light receiving surface of the imaging device, according to the Bayer system (Bayer-color-filter). Namely, raw data of a still image are read out from the imaging device, in which R, G, and B pixels are arranged in a checkerboard arrangement according to the Bayer system, and in an imaging process, an interpolation is performed regarding each of the pixels, so that three plane data of R, G, and B are generated, as disclosed in Japanese Patent Publication No. 2002-218482.

The G plane data greatly affect the image quality, and therefore, regarding an R-pixel or B-pixel that is an objective pixel, a correlation of the pixel data of the peripheral pixels which are positioned on the vertical line and the horizontal line passing through the objective pixel is obtained. Namely, using the pixel data of the pixels positioned on the side in which the correlation is relatively large, the G-pixel data of the objective pixel is obtained by an interpolation. For example, since, on a boundary line of vertical stripes in a vertical-stripe pattern image, the correlation in the vertical direction is greater, the G-pixel data of the objective pixel is obtained using pixel data of the pixels positioned in the vertical direction.

However, when a subject image has a portion in which different color dots are scattered in a uniform color area, such as a rough wall surface, or when raw data contains noise, the correlation is not necessarily obtained correctly. This causes the image process to be performed using pixel data of the pixels positioned on the side in which the correlation is relatively low, resulting in pixel data having a color component quite different from the original color component, so that the image quality is lowered.

### SUMMARY OF THE INVENTION

Therefore, an object of the present invention is to obtain correctly the correlation of the peripheral pixels around the objective pixel, so that G plane data is obtained with a high accuracy.

According to the present invention, there is provided an image processing device, in which, based on image data from red (R), green (G), and blue (B) pixels regularly arranged in a matrix, G-pixel data is obtained for the R-pixel or the B-pixel. The image processing device comprises a first correlation value calculating processor, a second correlation value calculating processor, and a pixel data calculating processor.

The first correlation value calculating processor obtains a first correlation value relating to the objective pixel, based on pixel data of related pixels which are positioned in vertical and horizontal directions relative to the R-pixel or the B-pixel which is an objective pixel. The second correlation value calculating processor obtains a second correlation value relating to four peripheral pixels which are positioned adjacent to the upper left, upper right, lower left, and lower right of the objective pixel. The pixel data calculating processor obtains vertical and horizontal correlations of pixel data of the objective pixel based on the first correlation value and the second correlation value. The pixel data calculating processor obtains the G-pixel data of the objective pixel, using pixel data of the G-pixel, and one of a R-pixel and a B-pixel positioned in a vertical direction of the objective pixel, when the vertical correlation is greater than the horizontal correlation. The pixel data calculating processor obtains the G-pixel data of the objective pixel, using pixel data of the G-pixel, and one of a R-pixel and a B-pixel positioned in a horizontal direction of the objective pixel, when the horizontal correlation is greater than the vertical correlation.

### BRIEF DESCRIPTION OF THE DRAWINGS

The objects and advantages of the present invention will be better understood from the following description, with reference to the accompanying drawings in which:

FIG. 1 is a block diagram showing an electrical and optical construction of a digital camera provided with an image processing device of an embodiment of the present invention;

FIG. 2 is a view showing the order in which image processes are performed in a digital signal processing circuit;

FIG. 3 is a view showing the arrangement and colors contained in image data obtained by an imaging device;

FIG. 4 is a view showing values of the image data obtained by the imaging device;

FIG. 5 is a view showing a distribution of correlation values K of each objective pixel in a comparison example;

FIG. 6 is a view showing G plane data in the comparison example;

FIG. 7 is a view showing the G plane data of FIG. 6 in a three dimensional manner;

FIG. 8 is a flowchart of an interpolation process routine;

FIG. 9 is a view showing a distribution of correlation values K of each objective pixel in the embodiment;

FIG. 10 is a view showing G plane data in the embodiment; and

FIG. 11 is a view showing the G plane data of FIG. 10 in a three dimensional manner.

### DESCRIPTION OF THE PREFERRED EMBODIMENTS

The present invention will be described below with reference to the embodiments shown in the drawings.

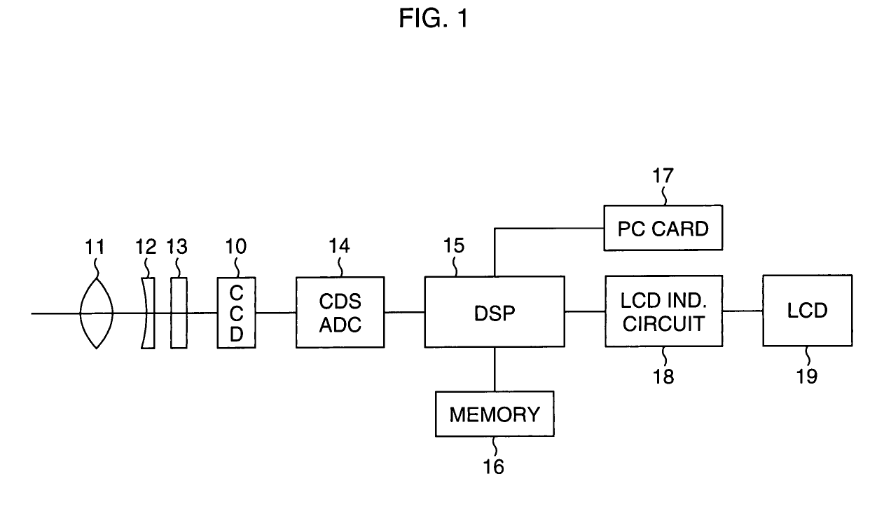

FIG. 1 is a block diagram generally showing an electrical and optical construction of a digital camera provided with an image processing device of an embodiment of the present invention. The digital camera is provided with a single imaging device (i.e., CCD) 10. Red (R), green (G), and blue (B) color filters, regularly arranged in a matrix, according to the Bayer system, for example, are provided on a light receiving surface of the imaging device 10. An infrared cut-off filter 12, an optical low-pass filter 13, and the imaging device 10 are disposed on the optical axis of a photographing lens 11, in this order. Accordingly, an infrared component and a noise component are removed from a light beam passing through the photographing lens 11, and the light beam is made incident on the imaging device 10, so that an analogue electric signal or image signal is generated in the imaging device 10.

The image signal is processed in an analogue signal processing circuit 14 provided with a correlated double sampling circuit (CDS) and an A/D converter (ADC), so that a noise component is removed from the image signal and the image signal is converted into a digital image signal, which is subjected to various image processes, described later, in a digital signal processing circuit 15.

The image signal processed in the digital signal processing circuit 15 is stored in a memory 16. The image data is then read out from the memory 16, is subjected to a compression process, and is recorded in a PC card 17 as a still image. The image data of the still image is subjected to a predetermined process in a LCD indication circuit 18, so that the still image is indicated by a liquid crystal display (LCD) 19 as a color image. Further, the image data output from the digital signal processing circuit 15 is directly input to the LCD indication circuit 18, so that a monitor image is indicated by the LCD 19 as a moving image.

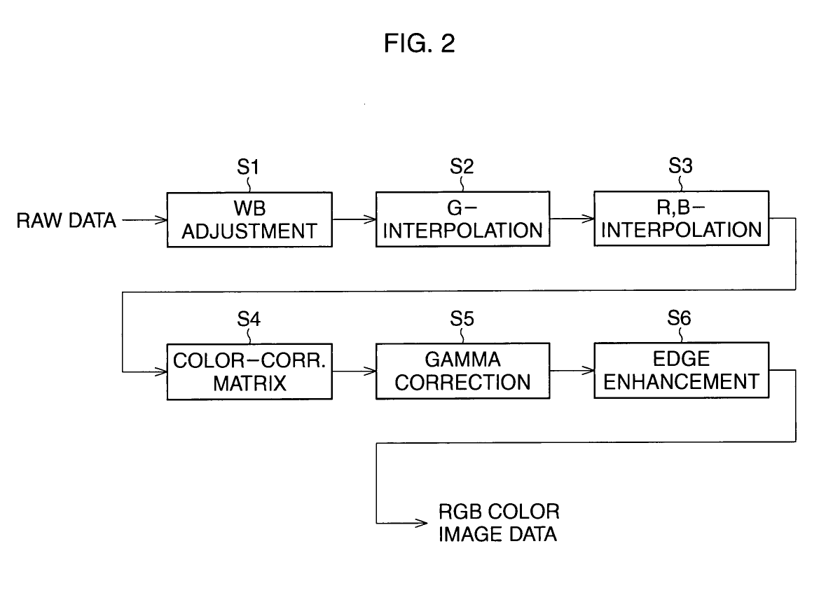

FIG. 2 is a view showing the order in which image processes are performed in the digital signal processing circuit 15. The image data (or raw data) input to the digital signal processing circuit 15 is subjected to a white balance adjustment in Step S1. In Step S2, a G-interpolation is executed, so that G-pixel data is obtained regarding R-pixels and B-pixels by the interpolation. In Step S3, an R-interpolation and B-interpolation are executed, so that R-pixel data and B-pixel data are obtained, regarding pixels which are neither R-pixels nor B-pixels, by the interpolation. Thus, regarding all of the pixels, R-, G-, and B-pixel data are obtained.

In Step S4, a color correction matrix operation is performed for the pixel data obtained as a result of Step S3, so that an error, generated due to the characteristics of the color filter, is removed. In Step S5, a gamma correction is performed on the pixel data subjected to the color correction matrix operation. In Step S6, an edge enhancement is performed. RGB color image data obtained by performing these processes are output to the LCD 19, or are subjected to a compression process and recorded in a PC card, as described above.

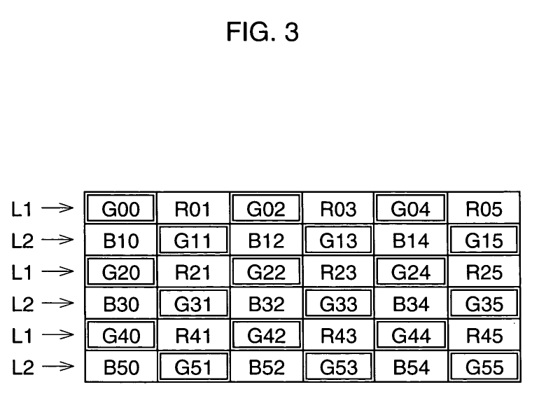

FIG. 3 shows the arrangement and colors of pixels contained in the image data (or raw data) obtained by the imaging device 10. The characters “R”, “G”, and “B” mean red, green, and blue. Accordingly, in the image data, a G-pixel and R-pixel are alternately arranged in the odd numbered rows from the top down, and a B-pixel and G-pixel are alternately arranged in the even numbered rows from the top down. The numerals indicate coordinates, and the origin of the coordinates is the left corner (i.e., G00). For example, in the third row from the top, G20, R21, G22, R23, . . . stand in a row from left to right. Note that, in FIG. 3, a G-pixel is indicated with a double frame.

With reference to FIGS. 3 through 7, the generation of G plane data in an example not utilizing the embodiment, i.e., a comparison example, is described.

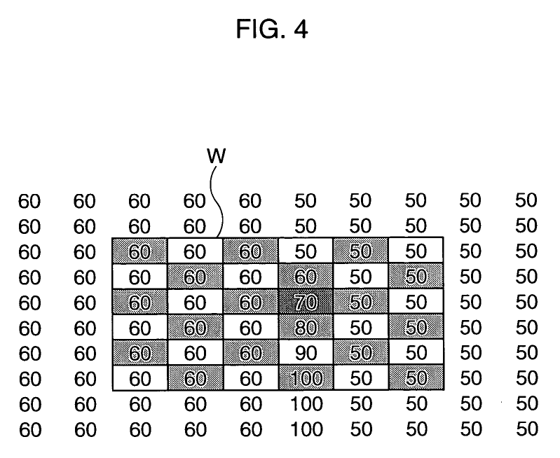

In FIG. 4, the part enclosed by a frame W corresponds to FIG. 3. Outside the frame W, the same pixel data as that for each pixel positioned in the outermost periphery of the frame W is repeated twice, so that the image data is expanded in each direction by two pixels. The shaded parts are G-pixels, and the thick shaded part (“70”) corresponds to R23 (see FIG. 3).

When the objective pixel is R23, a correlation coefficient K is calculated according to the following formula (1).

$$\begin{matrix}K = a ( \vert G22 - R23 \vert + \vert G24 - R23 \vert - \\ ( \vert G13 - R23 \vert + \vert G33 - R23 \vert ) ) + \\ b ( \vert G22 - G24 \vert - \vert G13 - G33 \vert ) + \\ c ( \vert R21 - R23 \vert + \vert R25 - R23 \vert - ( \vert R03 - R23 \vert + \vert R43 - R23 \vert )\end{matrix} \qquad ( 1 )$$

In the formula (1), a, b, and c are coefficients, which are experientially obtained. Further, in the formula (1), the references such as R23, G22, and G24 indicate the pixel data of the corresponding pixels. Note that, in the following explanation, also, the references such as “R23” in the formula indicates the pixel data of the corresponding pixels.

When the correlation coefficient K>0, it is determined that the vertical correlation of R23 is relatively large, and therefore, using the pixel data of related pixels positioned in vertical direction of R23, an interpolation is performed according to the following formula (2), so that G23 is obtained.

G23=(G13+G33)/2+(−R03+2R23−R43)/8 (2)

That is, the related pixels are G-pixels (G13, G33) which are adjacent to the upper and lower sides of R23, and R-pixels (R03, R43) which are adjacent to the upper or lower sides of these G-pixels.

Conversely, when the correlation coefficient K<0, it is determined that the horizontal correlation of R23 is relatively large, and therefore, using the pixel data of related pixels positioned in the horizontal direction of R23, an interpolation is performed according to the following formula (3), so that G23 is obtained.

G23=(G22+G24)/2+(−R21+2R23−R25)/8 (3)

That is, the related pixels are G-pixels (G22, G24) which are adjacent to right and left of R23, and R-pixels (R21, R25) which are adjacent to the right or left of these G-pixels.

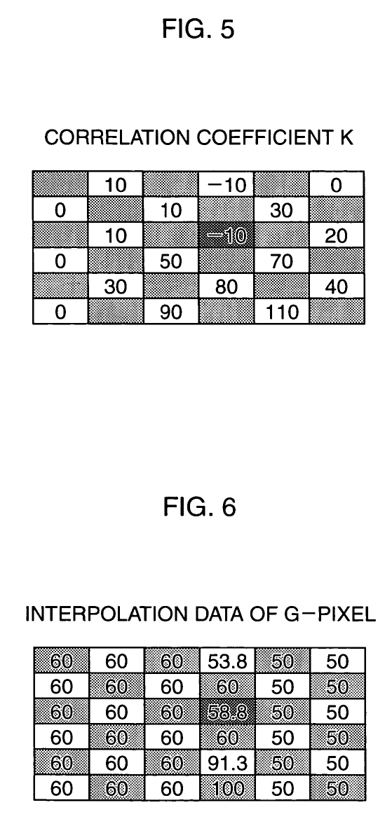

When the correlation coefficients K of the R-pixel and B-pixel in the example shown in FIG. 4 are obtained according to the formula (1), the result shown in FIG. 5 is obtained. Note that, in FIG. 5, shaded parts correspond to G-pixels, and there is no correlation coefficient k. The darker shaded part (“−10”) is a correlation coefficient K of the pixel of R23.

When the G-pixel data of all R-pixels and B-pixels are obtained according to the formulas (2) or (3), using the correlation coefficients K shown in FIG. 5, a result shown in FIG. 6 is obtained. Note that the coefficients a, b, and c of formula (1) are all 1.

The shaded parts in FIG. 6 are G-pixels, and the calculations using the formulas (2) and (3) are not carried out. The darker shaded part (“58.8”) is an interpolation data of G-pixel of R23 (i.e., G23). Since the correlation coefficient K (=−10) of the pixel of R23 is less than 0, as shown in FIG. 5, it is determined that the horizontal correlation is greater, so that G23=58.5 is obtained using the formula (3).

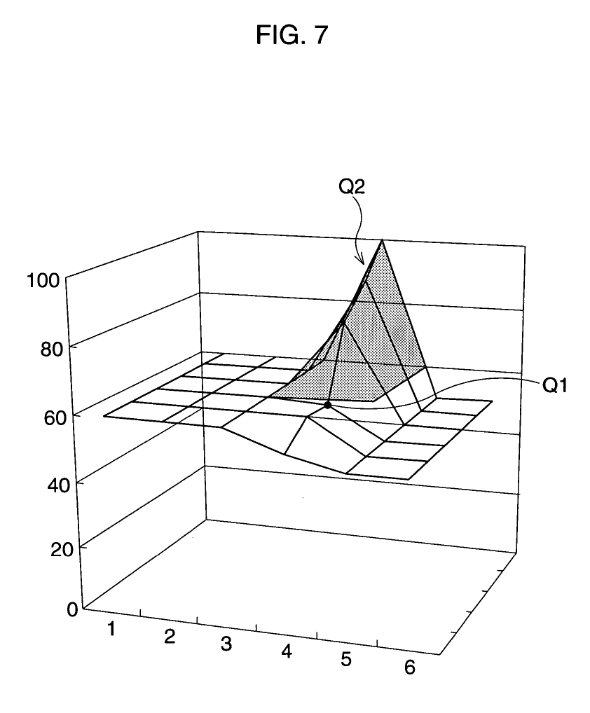

FIG. 7 shows G-pixel data of all the pixels obtained as described above, in a three dimensional manner, and parts, in which the pixel data are more than or equal to 60, are colored in black. As understood from FIG. 7, the pixel data (Q1) of G23 is smaller than the pixel data of the adjacent G-pixel, so that reference Q1 appears concave when viewing the ridged portion (Q2) from the right in the drawing. It is considered that the concave area appears because there is an error in the correlation coefficient K of the pixel when obtaining G23. Thus, in the embodiment, the correlation coefficient K, obtained with taking into consideration peripheral pixels positioned in oblique directions of the objective pixel, is used as described below.

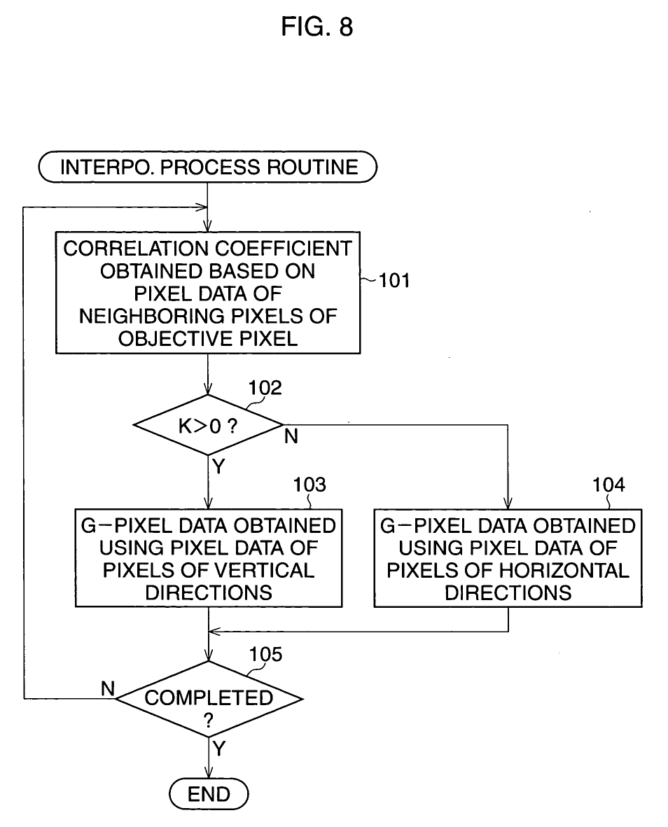

FIG. 8 is a flowchart of an interpolation process routine, by which G-pixel data of R-pixels and B-pixels that are objective pixels are obtained.

In Step 101, a single R-pixel or B-pixel is selected as an objective pixel, and a correlation coefficient K is obtained based on pixel data of pixels neighboring the objective pixel. The neighboring pixels include not only related pixels which are positioned in vertical and horizontal directions relative to the objective pixel, but also four peripheral pixels which are positioned adjacent to the upper left, upper right, lower left, and lower right of the objective pixel. For example, in the case of R23, the related pixels are R03, G13, G33, R43, R21, G22, G24, and R25, and the peripheral pixels are B12, B14, B32, and B34.

Taking R23 as an example, the correlation coefficient K is calculated according to the following formula (4).

$$\begin{matrix}K = a ( \vert G22 - R23 \vert + \vert G24 - R23 \vert - \\ ( \vert G13 - R23 \vert + \vert G33 - R23 \vert ) ) + \\ b ( \vert G22 - G24 \vert - \vert G13 - G33 \vert ) + \\ c ( \vert R21 - R23 \vert + \vert R25 - R23 \vert - \\ ( \vert R03 - R23 \vert + \vert R43 - R23 \vert ) + \\ d ( \vert G11 - G13 \vert + \vert G15 - G13 \vert + \\ \vert G31 - G33 \vert + \vert G35 - G33 \vert - \\ ( \vert G02 - G22 \vert + \vert G22 - G42 \vert + \vert G04 - G24 \vert + \vert G24 - G44 \vert ) )\end{matrix} \qquad ( 4 )$$

As understood from a comparison with formula (1), in formula (4), the term, multiplied by the coefficient d, is added, so that the peripheral pixels are taken into consideration. Note that the coefficient d can be determined arbitrarily based on experience similarly to the coefficients a, b, and c. Thus, these coefficients may have different values, or all the coefficients may be 1.

In the formula (4), the sum of three terms, multiplied by the coefficients a, b, and c, is a first correlation value, which is an index generally indicating the strengths of the vertical and horizontal correlations with respect to the objective pixel. The fourth term, multiplied by the coefficient d, is a second correlation value relating to the four peripheral pixels, and indicates which of the peripheral pixels, those in a horizontal direction or a vertical direction, have stronger correlation. The second correlation value is obtained based on the first absolute values of the differences between G-pixel data of G-pixels adjacent to the right and left of each of the peripheral pixels, and second absolute values of the differences between G-pixel data of G-pixels adjacent to the upper and lower sides of each of the peripheral pixels. In the embodiment, the second correlation value is obtained by multiplying the difference between the sum of the absolute values of the differences between G-pixel data of G-pixels adjacent to the right and left of each of the peripheral pixels, and the sum of the absolute values of the differences between G-pixel data of G-pixels adjacent to the upper and lower sides of each of the peripheral pixels, by the coefficient d.

Namely, the second correlation value is obtained by calculating the vertical and horizontal correlation values of pixels neighboring the objective pixel, based on the G-pixels in the four straight lines which form the shape “#” and that are offset upward, downward, to the right, and to the left by one pixel, from the objective pixel.

In Step 102, it is determined whether the correlation coefficient K is greater than 0. When K>0, it is judged that the vertical correlation is greater than the horizontal correlation. Thus, in Step 103, the G-pixel data of the objective pixel is obtained by an interpolation using pixel data of the related pixels positioned in the vertical direction of the objective pixel. The calculation is the same as that using formula (2).

Conversely, when K<0, it is judged that the horizontal correlation is greater than the vertical correlation. Thus, in Step 104, the G-pixel data of the objective pixel is obtained by an interpolation using pixel data of the related pixels positioned in the horizontal direction of the objective pixel. The calculation is the same as that using formula (3).

In Step 105, it is determined whether the processes of Steps 101 through 104 have been completed for all R-pixels and B-pixels. If the processes have not been completed, the process goes back to Step 101, so that the processes described above are executed again, and if the processes have been completed, the interpolation process routine ends.

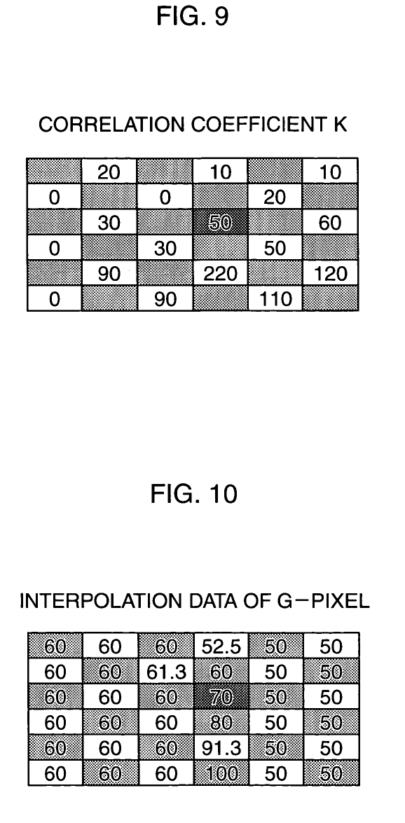

By obtaining the correlation coefficients K of the R-pixels and the B-pixels in the example shown in FIG. 4, the result shown in FIG. 9 is obtained. Similarly to FIG. 5, the shaded parts correspond to the G-pixels. The darker shaded parts (“50”) is a correlation coefficient K of the pixel of R23.

When the G-pixel data of all R-pixels and B-pixels are obtained according to the formulas (2) or (3), using the correlation coefficients K shown in FIG. 9, the G plane data shown in FIG. 9 is obtained. Note that the coefficients a, b, c, and d are all 1.

The darker shaded parts (“70”) in FIG. 10 show the G-pixel interpolation of R23 (i.e., G23). Since the correlation coefficient K (=50) of the pixel of R23, is greater than 0 as shown in FIG. 9, it is determined that the vertical correlation is greater, so that G23=70 is obtained using formula (2).

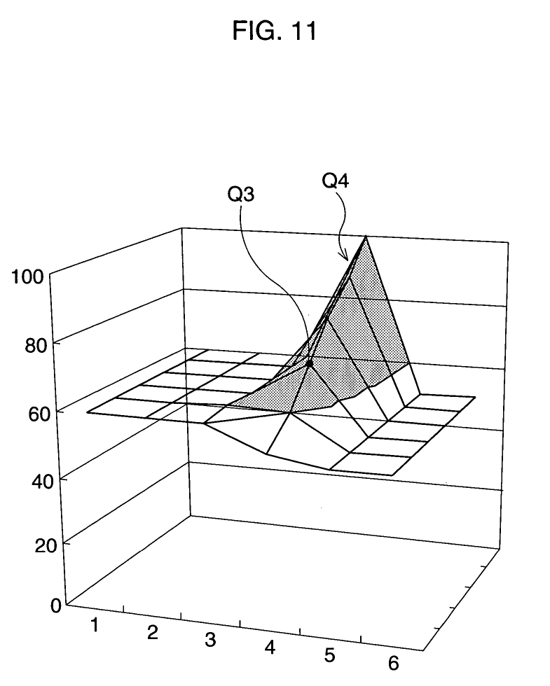

FIG. 11 shows G-pixel data of all the pixels obtained as described above, in a three dimensional manner, and parts, in which the pixel data are greater than or equal to 60, are colored in black. As understood from FIG. 11, the pixel data (Q3) of G23 has a value between that of the pixel data of the adjacent G-pixel, so that the part Q3 is smoothly connected to the adjacent portions when viewing the ridged portion Q4 from the right in the drawing (refer to the comparison example of FIG. 7). This is because the correlation coefficient K is determined by taking into consideration the second correlation value relating to the peripheral pixels of R23.

Therefore, according to the embodiment, even when a subject image has a portion in which different color dots are scattered in a uniform color area, such as a rough wall surface, or even when the subject image contains noise, the correlation is obtained correctly. Thus, the interpolation process is always performed using pixel data having greater correlation, so that pixel data having a color component close to the original color component is obtained, and therefore, the image quality is prevented from degrading.

Note that R-pixels and B-pixels are obtained by a normal or conventional interpolation process.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2003-015804 (filed on Jan. 24, 2003) which is expressly incorporated herein, by reference, in its entirety.

1. An image processing device in which red (R), green (G), and blue (B) pixels, (R-pixels, G-pixels, and B-pixels) are regularly arranged in a matrix so that, based on image data from said R-, G-, and B-pixels, G-pixel data is obtained for said R-pixel or said B-pixel, said image processing device comprising:
a first correlation value calculating processor that, based on pixel data of related pixels which are positioned in the vertical and horizontal directions relative to said R-pixel or said B-pixel, each of which is an objective pixel, obtains a first correlation value relating to said objective pixel by a calculation;
a second correlation value calculating processor that obtains a second correlation value relating to four peripheral pixels which are positioned adjacent to the upper left, upper right, lower left, and lower right of said objective pixel; and
a pixel data calculating processor that obtains vertical and horizontal correlations of pixel data of said objective pixel based on said first correlation value and said second correlation value, said pixel data calculating processor obtaining the G-pixel data of said objective pixel, using pixel data of said G-pixel, and one of said R-pixel and said B-pixel positioned in a vertical direction of said objective pixel, when said vertical correlation is greater than said horizontal correlation, said pixel data calculating processor obtaining the G-pixel data of said objective pixel, using pixel data of said G-pixel, and one of said R-pixel and said B-pixel positioned in a horizontal direction of said objective pixel, when said horizontal correlation is greater than said vertical correlation.

2. An image processing device according to claim 1, wherein said pixel data calculating processor obtains said vertical and horizontal correlations, based on a correlation coefficient obtained by multiplying different coefficients by said first correlation value and said second correlation value.

3. An image processing device according to claim 1, wherein said second correlation value is obtained based on first absolute values of the differences between G-pixel data of G-pixels adjacent to the right and left of each of said peripheral pixels, and second absolute values of the differences between G-pixel data of G-pixels adjacent to the upper and lower sides of each of said peripheral pixels.

4. An image processing device according to claim 1, wherein said second correlation value is obtained based on the sum of third absolute values of the differences between G-pixel data of G-pixels adjacent to the right and left of said four peripheral pixels, and the sum of fourth absolute values of the differences between G-pixel data of G-pixels adjacent to the upper and lower sides of each of said four peripheral pixels.
